(19) United States
(12) Patent Application Publication
(10) Pub. No.: US 2006/0149696 A1
(43) Pub. Date: Jul. 6, 2006

(54) Method and systems for controlling access to a data object by means of locks

(76) Inventors: Thorsten Pferdekaemper, Walldorf (DE); Martin Fischer, Heidelberg (DE)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/526,750

(22) PCT Filed: Sep. 4, 2003
(86) PCT No.: PCT/EP03/09827

§ 371 Date: Nov. 14, 2005

Related U.S. Application Data
(60) Provisional application No. 60/408,901, filed on Sep. 9, 2002.
(60) Provisional application No. 60/408,905, filed on Sep. 9, 2002.
(60) Provisional application No. 60/408,903, filed on Sep. 9, 2002.
(60) Provisional application No. 60/408,902, filed on Sep. 9, 2002.
(60) Provisional application No. 60/409,606, filed on Sep. 11, 2002.
(60) Provisional application No. 60/409,593, filed on Sep. 11, 2002.

(51) Int. Cl. G06F 17/30

(52) U.S. Cl. 707/1

(57) ABSTRACT

Methods, a computer readable medium, and systems are provided accessing a data object having an identifier in a computer system. The ID may be stored in a second lock object. Systems and methods consistent with the invention may determine whether the ID was stored successfully, and upon a successful storage, may check, before accessing the data object, whether the ID is contained in a first lock object. If the ID is contained in a first lock object, systems and methods consistent with the invention may determine whether a link to a storage location is assigned to the ID in the first lock object. If the link is not assigned to the ID, the ID may be deleted form the first lock object and a read and/or write access may be performed on the data object.

### BACKGROUND OF THE INVENTION

1. Field of the Invention

The technical field of this invention is in the area of electronic data processing. More particularly, the invention relates to methods, computer program products and systems for accessing data objects, particularly in the context of data moving.

2. Description of the Related Art

Moving of data objects is well known to every user of a computer and is a standard procedure, which is routinely applied. A special application of moving data objects is the archiving process, by which data objects are moved from a first to a second storage location for safety and/or performance reasons. In enterprises, enterprise resource planning software (ERP) applications are used to control or support business processes and the management of the enterprise. ERP software is further used to manage company information of enterprises of various kinds in any field of technology by means of automatic data processing systems such as computers or computer systems. During the use of such software a huge amount of data is usually created, which contains important business information and which has to be archived from time to time.

According to the state of the art (see Helmut Stefani, Datenarchivierung mit SAP, Galileo Press GmbH, Bonn 2002, ISBN 3-89842-212-7), archiving can be performed automatically by archiving software tools, which can be part of the ERP software. Such tools can consist of a writing module, which stores (writes) the data objects to be archived sequentially in archive files, and a deleting module, which deletes the successfully archived data from the original data object base. The writing module can select the data objects to be archived from the data base according to specific criteria, e.g. the creation time of the data. It usually does not modify the original data objects or data base. The deleting module staggeredly reads the archive file sequentially and deletes the data objects found in the archive file from the original data base. This ensures that only such data objects are deleted from the original data base, which are readably stored in the archive file. The time for the archiving procedure as a whole depends on the amount of data and varies from a few milliseconds to several hours or days. Consequently, there is in many cases a considerable time gap between writing the data into the archive file and deleting the data from the original data base. This time gap can be a reason for the following problems:

As long as the data objects are still available in the original data base, they can still be modified by any software application during said time gap. Because the deleting program does not compare the archived data object and the data object to be deleted, such modifications can be lost. This has not only the consequence of the loss of the amended data, it can additionally have the consequence that certain business processes can not be completed.

An other problem arises, if several archiving processes run in parallel. Then it can happen, that one data object is archived several times, and is no longer unambiguously identifiable. This can have the consequence that evaluations or statistical analysis, which use the archive files, produce wrong results.

It can also happen that data objects in the original data base are read by the writing module and are simultaneously modified by an other software application. In such a case, the data can be transferred from an archiveable status to a non archiveable status. In consequence, data objects which are not archiveable are written into the archive file and are deleted from the original data base. In effect, this can result in a loss of data.

Thus, there is a need for a method, software application and/or data processing system providing a more efficient solution of the problems described above, particularly it is desirable to provide a software application having a control mechanism, which prevents the modification during a moving or archiving process.

### SUMMARY OF THE INVENTION

In accordance with the invention, as embodied and broadly described herein, methods and systems consistent with the principles of the invention provide for accessing in a computer system a data object having an identifier (ID), comprising:

checking, before accessing said data object, whether said ID is contained in a first lock object and whether a link to a storage location is assigned to said ID in said first lock object, and in case said ID is not contained in said first lock object and/or no link is assigned to said ID, performing a read and/or write access on said data object, else, skipping said access.

By using this method, software applications, which require access to data objects, can check by querying the lock object, whether the data to be accessed are subject to a moving process or not. If yes, the access to that data can be postponed until the moving is completed.

In accordance with another aspect, the invention, as embodied and broadly described herein, methods and systems consistent with the principles of the invention provide a computer system for processing data by means of or in a software application, comprising:
memory for storing program instructions;
input means for entering data;
storage means for storing data;
a processor responsive to program instructions
programm instructions to carry out a method as of any of claims 1 to 12.

The invention and its embodiments are further directed to a computer readable medium and a carrier signal comprising instructions for processing data according to the inventive method and in its embodiments.

An advantage of the invention and its embodiments is that the security against data loss in data moving and archiving procedures is greatly improved. This avoids in consequence a lot of time and money for data retrieving.

Additional objects and advantages of the invention and its embodiments will be set forth in part in the description, or can be learned by practice of the invention. Objects and advantages will be realized and attained by means of the elements and combinations particularly pointed out in the appended claims. Embodiments of the invention are disclosed in the detailed description section and in the dependent and appended claims as well.

It is understood that both the foregoing general description and the following detailed description are exemplary and explanatory only and are not restrictive of the invention and its embodiments, as claimed.

### BRIEF DESCRIPTION OF THE DRAWINGS

The accompanying drawings, which are incorporated in and constitute a part of this specification, illustrate examples of embodiments of the invention and, together with the description, explain the principles of the invention. In the drawings,

FIG. 1 is a schematic block diagram of the implementation of the inventive method within a computer system.

FIG. 2 is a schematic diagram of an exemplary structure of a lock object and a data object in accordance with the principles of the inventive method.

FIG. 3 is an exemplary flow diagram of an implementation of the creation of a first and second lock object shown in FIG. 1.

FIG. 4 is an exemplary flow diagram of an alternative implementation of the creation of a first and second lock object shown in FIG. 1.

FIG. 5 is an exemplary flow diagram of an implementation of a deleting process in the context of data moving/archiving.

FIG. 6 is an exemplary flow chart of a further implementation of the creation of a first and second lock object.

FIG. 7 shows an exemplary flow chart of how any software application can use the concept of the P- and T-locks.

FIG. 8 shows a process alternative to that shown in FIG. 7, including a conditional deletion of a P-lock.

FIG. 9 shows an example of a flow chart for a software module by means of which the locks can be deleted.

### DETAILED DESCRIPTION

Computer system and program are closely related. As used hereinafter, phrases, such as “the computer provides” and “the program provides or performs specific actions”, “a user performs a specific action” are convenient abbreviation to express actions by a computer system that is controlled by a program or to express that the program or program module is designed to enable the computer system to perform the specific action or the enable a user to perform the specific action by means of a computer system.

Reference will now be made in detail to the principles of the invention by explaining the invention on the basis of the archiving process, examples of which are illustrated in the accompanying drawings. Examples, mentioned therein, are intended to explain the invention and not to limit the invention in any kind.

Within the concept of this description, the terms used shall have their usual meaning in the context of the field of data processing unless defined otherwise in the following section:

A computer system can be a stand alone computer such as a PC or a laptop or a series of computers connected as a network, e.g. a network within a company, or a series of computers connected via the internet. A data object to be archived can be any kind or type of data, e.g. numerical or textual data, image data, meta data, irrespective whether the data are implemented as whole files or parts of files or fields in tables, irrespective whether they are stored in volatile memory or nonvolatile memory. As an example, data objects according to the present invention can be implemented as one or more fields of one or more tables, particularly of tables of a relational data base system, or as objects in an object orientated programming language.

The term ERP software shall be considerer to comprise any software application that supports the business processes of an enterprise.

A storage location is a volatile or nonvolatile storage means accessible by the computer system. It can be any kind of computer storage means known to one of ordinary skill, e.g. RAM, magnetical or optical storage, such as floppy disk, hard disk, MO-Disk, CD-ROM, CD RW, DVD ROM, DVD RW, etc.

An identifier (ID) is a type of data, which allows an unambiguous identification of the data object to be archived, it can be implemented for example as a number or a combination of alphanumerical characters or as a characteristic part of the data object to be archived. It is clear from that definition that a data object can have a wide variety of IDs. A lock object is a data object, in which the identifiers are stored. It can be implemented e.g. as a file on a storage means or as a data array in computer memory. A first lock object can be stored advantageously in a nonvolatile storage means and a second lock object can be stored in volatile and/or nonvolatile storage means.

The assignment of a storage location to an ID can be implemented by a table, in which one field of a line contains the ID and an other field of that line contains a link to the second storage location, e.g. a file name. This table can be stored as a file on a nonvolatile storage means.

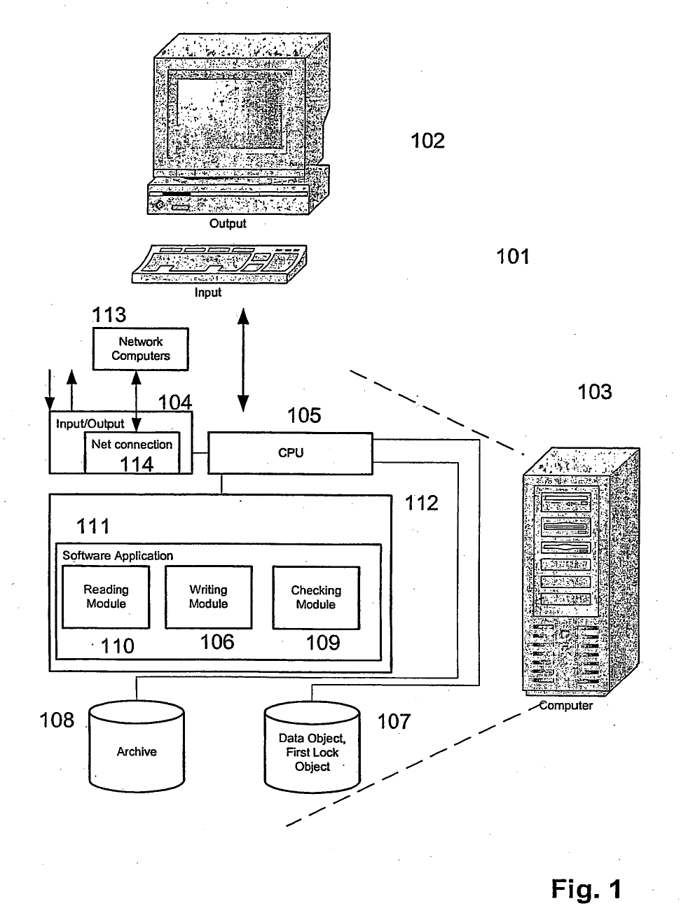

FIG. 1 depicts one example of an implementation of a first embodiment of the invention. FIG. 1 shows a computer system 101 comprising a computer 103 having a CPU 105, a working storage 112, in which an software application 111 is stored for being processed by CPU 105. Software application 111 comprises program modules 106, 109, 110 for carrying out reading access, writing access and for checking whether the IDs of the selected data objects are contained in the first lock object.

Computer System 101 further comprises input means 113, output means 112 for interaction with a user, and general input/output means 104, including a net connection 114, for sending and receiving data. A plurality of computer systems 101 can be connected via the net connection 114 in the form of a network 113. In this case the network computers 113 can be used as further input/output means, including the use as further storage locations. Computer system 103 further comprises a first storage means 107, in which the data objects and the first lock object are stored. A second storage means 108, is available for archiving purpose.

In case the program modules 106, 109, 110 are processed by CPU 105 in order to carry out the inventive process, one or more data objects stored in the first storage means 107 are selected and the checking module 109 checks before the data objects are accessed by reading module 110 or writing module 106, whether the ID of the selected data object or objects is contained in the first lock object and whether a link to the second or first storage location 107, 108 or to a file on these storage locations is assigned to said ID in said first lock object. In case said ID is not contained in said first lock object and/or no link is assigned to said ID, the call of the reading or writing module is skipped. The software application 111 can then be terminated and started anew at a later time. Alternatively, checking module 109 can be repeatedly called until the data object is free for access.

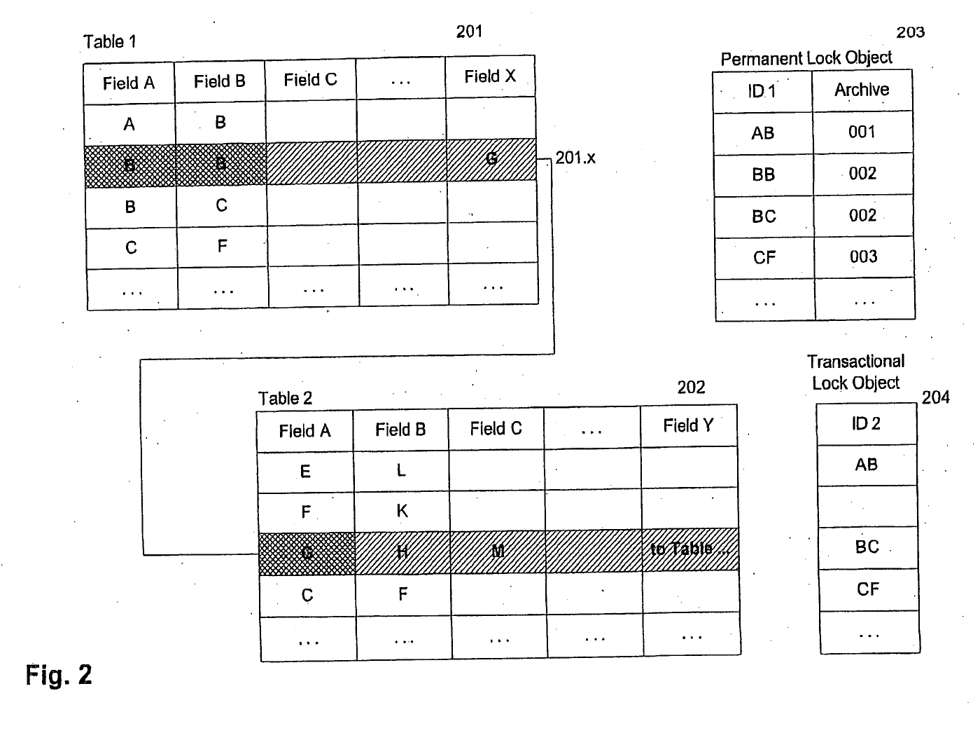

In a second implementation of the invention, a data object comprises one or more fields of one or more tables, and the ID of the respective object comprises one or more key fields of that data object. This can be seen from FIG. 2. In this instance, various sets of data objects are created in the form of two-dimensional data arrays, i.e. two tables having columns named field A to field X and field Y, respectively, and a certain, unspecified number of lines. A field of the array or table is defined by the name of the column and the respective line. Such field can contain data to be archived. It can alternatively contain a reference to a line of a further table. For example, in table 1 field X in line 2 contains a reference to line 3 in table 2. A data object to be archived comprises fields of one line of the respective table. If one of the fields contains a reference to a line of an other table, fields of this referenced line belong to the data object, too. In the example in FIG. 2, a data object to be archived comprises the fields of line 2 in table 1 and fields of line 3 in table 2.

An ID of such a data object can be implemented by the content of one or more so-called key fields, if the combination of these key fields is unique within the respective table. In the example, the fields of “field A” and “field B” can be used as key fields for table 1, whereas field A alone is key field in table 2. Within this example, the data object has the content of the fields of columns field A and B of the respective lines as ID. The ID for the data object to be archived is stored as a first type ID in a first type lock object, named persistent lock object in FIG. 2, and as a second type ID in a second type lock object, named transactional lock object. The persistent lock object is implemented as a table having two columns, the first of which contains the first type ID 1. The second type ID, ID 2, can be implemented as a one dimensional data array stored in the working memory of the computer system. However, it can be implemented as a file on a nonvolatile storage means, too. The first type ID, ID 1, is deleted in a moving or archiving process after the selected data object has been deleted from its original storage location. The second type ID, ID 2, is deleted immediately after a read or write access on a data object has been completed. Alternatively, type ID 1 IDs can be deleted after all the selected data objects have been deleted from the original storage location. As can be seen, both ID types have identical content, the ID of the respective lines of the data to be moved/archived. The persistent lock objects further contain a column by which a filename is assigned to the ID of the data object, i.e. that data object to be archived. In the example, line 1 is archived in a file named 001, lines 2 and 3 in file 002, and line 4 in file 003.

Selection of the data object can be implemented by an automatic procedure, such as a simple query, that returns all lines having a certain field that satisfy a certain condition. For example, the procedure could return all lines in which the content of a date field pre-dates or postdates a certain deadline. Selection can also be implemented by a user to whom a selection table is presented via a graphical user interface.

A further embodiment is characterized in that said link is a filename or a link to a file.

A further embodiment is characterized in that said first lock object is created by an data moving process.

In a further embodiment the invention comprises before performing said check, storing said ID in a second lock object, which is stored in a volatile storage means.

Additionally, the invention comprises checking, whether the ID has been successfully stored in the second lock object, and in case no, skipping accessing the data object.

An other embodiment is characterized by said second lock object is a data array. Advantageously, said data array is one dimensional.

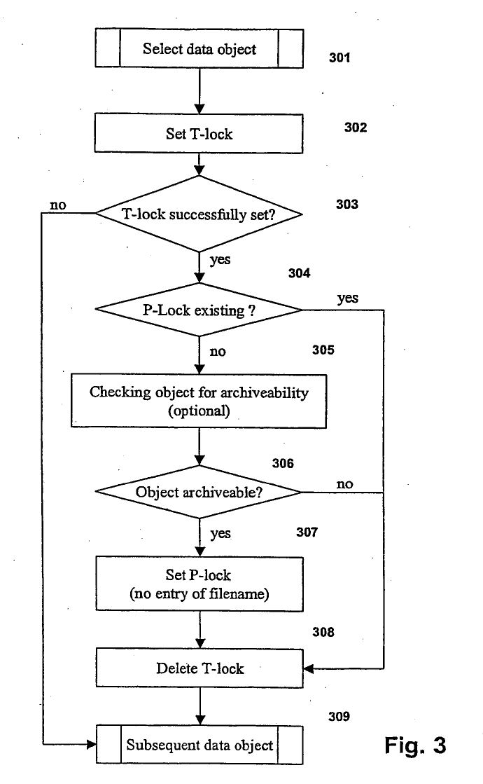

In order to better understand the inventive process and its advantages, the creation of a lock object is now described in more detail with reference to FIGS. 3 to 5, which are schematic flow diagrams of exemplary implementations of a data moving or archiving processes, respectively, as shown in FIG. 1. Within-the context of this description, and particularly the FIGS. 3 to 9, a first type ID is called a P-lock (permanent) and a second type ID is called a T-lock (transactional). So, setting a P- or T-lock for a selected object means to store an ID of that object in a respective-lock object. The term “permanent” results for the property of the P-lock of existing permanently, as long as the data object is not yet deleted from its original storage location. The term “transactional” results from the property of the T-lock of existing only as long as a specific action (e.g. checking of archiveability) is performed on a selected data object or, in other words, of being deleted shortly after the respective action has been performed.

In the flow chart of the selecting module in FIG. 3, a data object is selected in a first step 301. Subsequently, a T-lock is set on this object in a second step 302. If the T-lock was successfully set (step 303), that is, if it did not yet exist, it is checked in step 304 whether a P-lock already exists in the selected data object. If not, the next data object is selected in step 309. The setting of the T-lock (step 302). and the check (step 303) whether it is successfully set can advantageously be implemented as one “atomic” step. This means that both steps can be executed essentially at the same time or, in other words, the time gap between both steps can be essentially zero.

Both checks (steps 303 and 304) can also be implemented by querying the respective lock objects. If a P-lock exists, the T-lock is deleted (step 308) and the next data object is selected (step 309). If no P-lock exists, it is checked in steps 305 and 306, whether the data object is archiveable. Such checking comprises a test whether the data in the data object is readable, complete, not fraught with obvious failures, etc. If the test is successful, a P-lock is set on that data object in step 307, whereby no archive file is assigned to the data object at that point. Then the T-lock is deleted (step 308) and the next data object is selected (step 309).

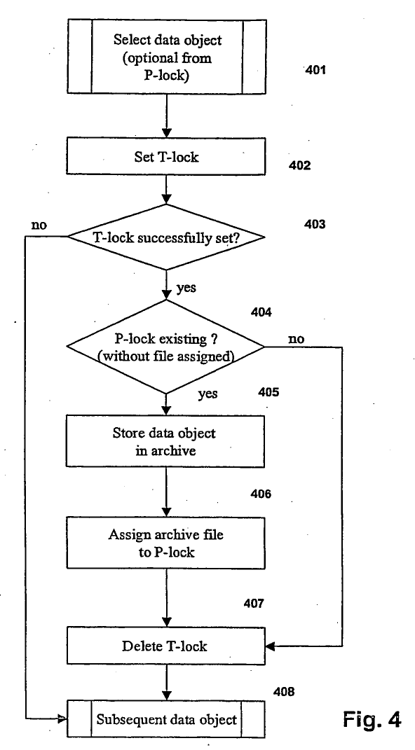

In the flow chart of the writing module in FIG. 4, a data object is selected in a first step 401. Subsequently, a T-lock is set on this object in step 402. If the T-lock was successfully set (step 403), it is checked in step 404 whether a P-lock already exists in the selected data object, whereby no file must be assigned to that data object at that point of the process. If the condition is not fulfilled, the T-lock is deleted in step 407, and the next data object is selected in step 408. If a P-lock exists, the data object is stored in an archive file in step 405 and the archive file is assigned to the data object in step 406, e.g. by adding the file name to the lock object as shown in FIG. 2. Subsequently, the T-lock is deleted (step 407), and the next data object is selected (step 408).

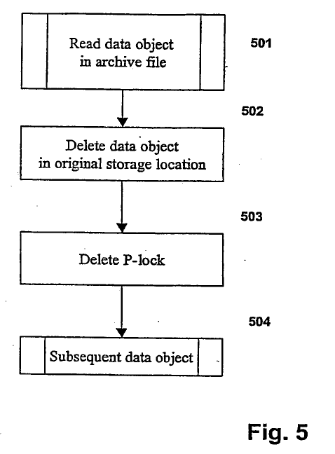

In the flow chart of the deleting module in FIG. 5, a data object that has already been archived is selected (step 501). This can be implemented by checking the archive files. If a data object has been selected and successfully read from the archive file, that data object is deleted from the original storage location (step 502), the P-lock is deleted (step 503), and the next data object is selected (step 504).

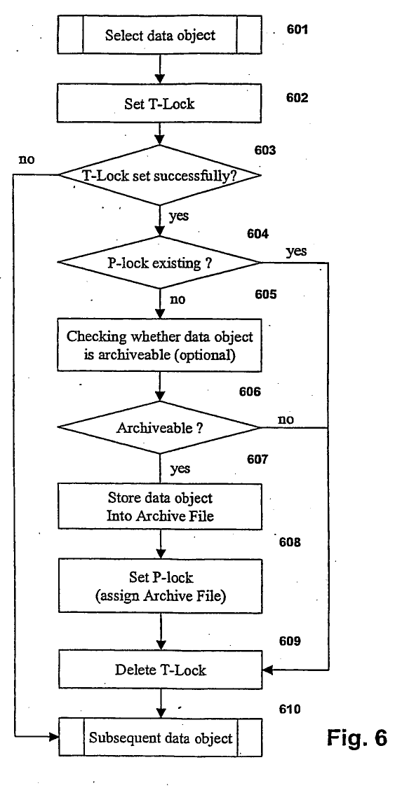

In the exemplary flow chart of a further exemplary implementation of the creation of a lock object in FIG. 6, the processes, as described above with respect to FIGS. 3 and 4, are combined to one module. Accordingly, a data object is selected in a first step 601. Subsequently, a T-lock is set on this object in step 602. If the T-lock was successfully set (step 603), it is checked in step 604 whether a P-lock already exists in the selected data object. If not, the next data object is selected (step 610). If a P-lock exists on that object, the T-lock is deleted (step 609) and the next data object is selected (step 610). If no P-lock exists on that object, it is checked in step 605, whether the data object is archiveable. If this check fails (step 606), the T-lock is deleted (step 609), and the next data object is selected (step 610). If the check is positive, the data object is stored (step 605) in an archive file, a P-lock is set (step 608) with the archive file assigned, the T-lock is deleted (step 609) and the next data object is selected (step 610).

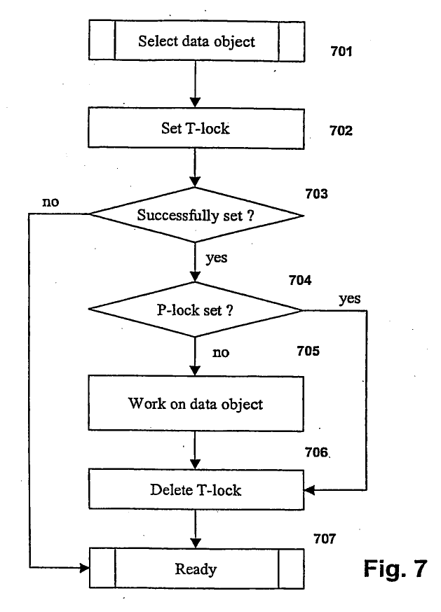

FIG. 7 shows by way of an exemplary flow chart how any software application according to the invention can use the concept of the P- and T-locks to ensure that the measures, the software application is going to apply on the data object, do not influence the archiving process. A software application which is programmed to have a read and/or write access to data objects, which can be subject of an archiving process as described, comprises the following steps as shown in FIG. 7. In a first step 701, the data object is selected. Then a T-lock is set in step 702 on that object by the application. If the T-lock is successfully set (step 703), it is checked in step 704, whether a P-lock exists on that object, otherwise the application terminates in step 707. If a P-lock exists on that object, the T-lock is deleted (step 706) and the application terminates (step 707). If no P-lock exists, i.e. the data object is not subject to an archiving process, the application can have read/write access to the data object in a working step 705. Subsequently the application deletes the T-lock (step 706) and terminates (step 707).

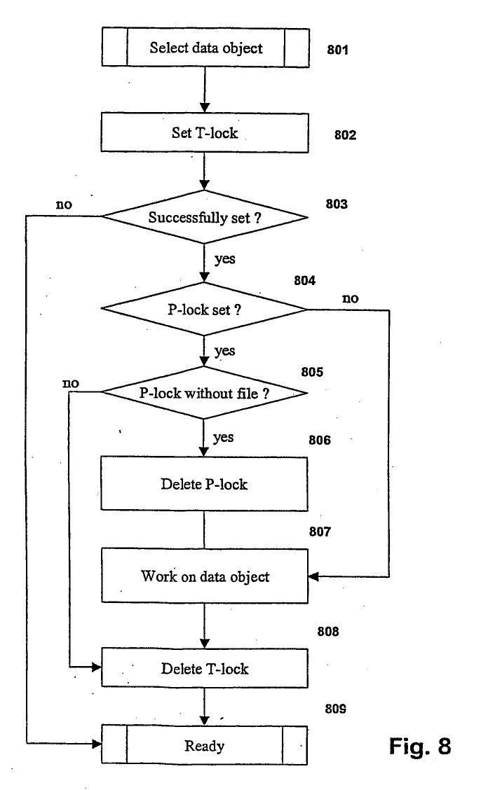

FIG. 8 shows a process alternative to that shown in FIG. 7, including a conditional deletion of a P-lock. In a first step 801, the data object is selected. Then a T-lock is set on that object by the application (step 802). If the T-lock is successfully set (step 803), it is checked (step 804), whether a P-lock exists on that object, otherwise the application terminates (step 809). If no P-lock exists (step 804), i.e. the data object is not subject to an archiving process, the application can have read/write access to the data object in working step 807. Subsequently, the application deletes the T-lock (step 808) and terminates (step 809). If a P-lock exists (step 804), it is checked (step 805), whether a file is assigned to it. If a file is assigned, the application deletes the T-lock (step 808) and terminates (step 809). If no file is assigned, the P-lock is deleted (step 806), and the application can have read/write access to the data object (step 807). Subsequently, the application deletes the T-lock (step 808) and terminates 809 (step 809).

This procedure is particularly useful, in that data objects, which are not yet stored in an archive file, can be still altered. Consequently, they can be archived only at the next archive run.

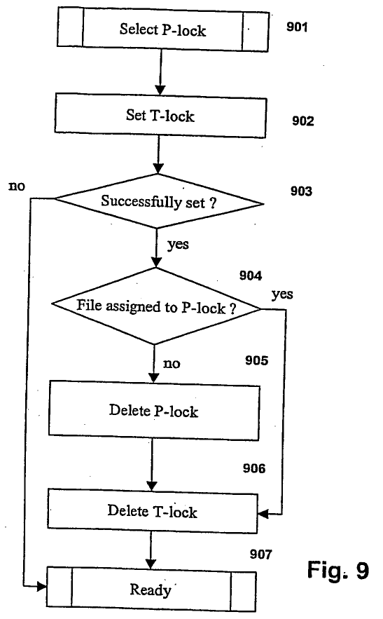

FIG. 9 shows an example of a flow chart for a software module by means of which the locks set by the modules described above can be deleted. This can be useful in cases in which no archive files are assigned to P-locks or in which P-locks have been deleted for a user. Therein, a P-lock is nothing else than a data object and can be treated in the same way as described above. In a first step 901, a P-lock is selected. Then a T-lock is set to the P-lock (step 902). If the T-lock is successfully set (step 903), it is checked in step 904, whether the P-lock has a file assigned. If the T-lock is not set successfully the module terminates (step 907). If the selected P-lock has no file assigned (step 904), the P-lock is deleted (step 905). Then the T-lock is deleted (step 906), and the module terminates (step 907). Alternative to the termination (step 907), a next P-lock can be selected.

Modifications and adaptations of the present invention will be apparent to those skilled in the art from consideration of the specification and practice of the invention disclosed herein. The foregoing description of an implementation of the invention has been presented for purposes of illustration and description. It is not exhaustive and does not limit the invention to the precise form disclosed. Modifications and variations are possible in light of the above teachings or can be acquired from the practicing of the invention. For example, the described implementation includes software, but systems and methods consistent with the present invention can be implemented as a combination of hardware and software or in hardware alone. Additionally, although aspects of the present invention are described for being stored in memory, one skilled in the art will appreciate that these aspects can also be stored on other types of computer-readable media, such as secondary storage devices, for example, hard disks, floppy disks, or CD-ROM; the Internet or other propagation medium; or other forms of RAM or ROM. It is intended that the specification and examples be considered as exemplary only, with a true scope and spirit of the invention being indicated by the following claims.

Computer programs based on the written description and flow charts of this invention are within the skill of an experienced developer. The various programs or program modules can be created using any of the techniques known to one skilled in the art or can be designed in connection with existing software. For example, programs or program modules can be designed in or by means of ®Java, C++, HTML, XML, or HTML with included Java applets or in SAP R/3 or ABAP.

1. A method for accessing in a computer system a data object having an identifier (ID), comprising:
storing the ID in a second lock object; and
determining whether the ID was stored successfully, and upon a successful storage, checking, before accessing the data object, whether the ID is contained in a first lock object and if the ID is contained in the first lock object, whether a link to a storage location is assigned to the ID in the first lock object, and if the link is not assigned to the ID, deleting the ID from the first lock object and performing a read and/or write access on the data object.

2. The method of claim 1, wherein the first lock object is a file stored on a nonvolatile storage means.

3. The method of claim 1, wherein the first lock object comprises a table, having a column for the ID and a column for the link of the ID to a storage location.

4. The method of claim 1, wherein a each data object comprises one or more fields of one or more tables and wherein the ID comprises one or more key fields of the one or more tables.

5. The method of claim 4, wherein the link is a filename or a link to a file.

6. The method of claim 1, wherein the first lock object is created by a data moving process.

7. The method of claim 1, wherein the second lock object is stored in a volatile storage means.

8. The method of claim 1, wherein the second lock object is a data array.

9. The method of claim 8 wherein the data array is one dimensional.

10. The method of claim 1 for use in an enterprise resource planning software.

11. A computer system for processing data, comprising:
memory means for storing program instructions;
input means for entering data;
storage means for storing data;
a processor responsive to the program instructions, wherein the
program instructions comprise program code means for performing a method for accessing a data object having an identifer, the method comprising:
storing the ID in a second lock object; and
determining whether the ID was stored successfully, and upon a successful storage, checking, before accessing the data object, whether the ID is contained in a first lock object and if the ID is contained in the first lock object, whether a link to a storage location is assigned to the ID in the first lock object, and if the link is not assigned to the ID, deleting the ID from the first lock object and performing a read and/or write access on the data object.

12. A computer readable medium comprising instructions for performing a method for accessing a data object having an identifier in a computer system, the method comprising:
storing the ID in a second lock object; and
determining whether the ID was stored successfully, and upon a successful storage, checking, before accessing the data object, whether the ID is contained in a first lock object and if the ID is contained in the first lock object, whether a link to a storage location is assigned to the ID in the first lock object, and if the link is not assigned to the ID, deleting the ID from the first lock object and performing a read and/or write access on the data object.

13. (canceled)

14. (canceled)

15. The computer readable medium of claim 12, wherein the first lock object is a file stored on a nonvolatile storage means.

16. The computer readable medium of claim 12, wherein the first lock object comprises a table, having a column for the ID and a column for the link of the ID to a storage location.

17. The computer readable medium of claim 12, wherein each data object comprises one or more fields of one or more tables and wherein the ID comprises one or more key fields of the one or more tables.

18. The computer readable medium of claim 12, wherein the link is a filename or a link to a file.

19. The computer readable medium of claim 12, wherein the first lock object is created by a data moving process.

20. The computer readable medium of claim 12, wherein the second lock object is stored in a volatile storage means.

21. The computer readable medium of claim 12, wherein the second lock object is a data array.

22. The computer readable medium of claim 12, wherein the data array is one dimensional.

23. A computer system for processing data, comprising:
means for storing an identifier (ID) in a second lock object; and
means for determining whether the ID was stored successfully, and upon a successful storage, checking, before accessing the data object, whether the ID is contained in a first lock object and if the ID is contained in the first lock object, whether a link to a storage location is assigned to the ID in the first lock object, and if the link is not assigned to the ID, deleting the ID from the first lock object and performing a read and/or write access on the data object.

24. The computer system of claim 23, wherein first lock object is a file stored on a nonvolatile storage means.

25. The computer system of claim 23, wherein the first lock object comprises a table, having a column for the ID and a column for the link of the ID to a storage location.

26. The computer system of claim 23, wherein each data object comprises one or more fields of one or more tables and wherein the ID comprises one or more key fields of the one or more tables.

27. The computer system of claim 23, wherein the link is a filename or a link to a file.

28. The computer system of claim 23, wherein the first lock object is created by a data moving process.

29. The computer system of claim 23, wherein the second lock object is stored in a volatile storage means.

30. The computer system of claim 23, wherein the second lock object is a data array.

31. The computer system of claim 23, wherein the data array is one dimensional.
